(19) United States
(12) Patent Application Publication
(10) Pub. No.: US 2007/0221033 A1
(43) Pub. Date: Sep. 27, 2007

(54) Cutting Knife for Rotary Cutting Installations

(75) Inventor: Michael Taffertshofer, Weilheim (DE)

Correspondence Address: TIAJOLOFF & KELLY, CHRYSLER BUILDING, 37TH FLOOR, 405 LEXINGTON AVENUE, NEW YORK, NY, 10174, US

(73) Assignee: Gramatec GmbH, Weilheim (DE)

(21) Appl. No.: 11/587,912

(22) PCT Filed: Apr. 26, 2005
(86) PCT No.: PCT/DE05/00763

§ 371 Date: Oct. 26, 2006

(30) Foreign Application Priority Data
Apr. 26, 2004 (DE) 10 2004 020 256.7

(51) Int. Cl. B23D 61/00

(52) U.S. Cl. 83/846

(57) ABSTRACT

The invention relates to a cutting knife for rotary cutting installations for printed products or webs of flexible materials such as paper, plastic, fabric, leather or wood, especially multi-layer paper products that are separated in a tiled arrangement. Said cutting knife has a substantially circular, discoid cutting base having an axis of rotation which is substantially disposed in the center of the disk, and cutting sections at the edge of said base. The cutting sections have at least two different alternating areas. The first area is configured as a kind of saw tooth by notching the cutting base and the second area is configured as a kind of paring knife and extends conically towards the edge of the cutting knife relative to a width of the cutting base. The cutting base, in the second area, has an at least partially larger radius than in the first area. From an angle in which the cutting base rotates clock-wise for cutting, an edge of the second area extending on the periphery of the cutting base forms an angle ranging between 40 and 85° with the radius of the cutting base and at least one section that is in contact with the printed products during operation of the cutting knife has a cutting edge.

The present invention relates to a cutting knife for rotary cutting installations for cutting paper, especially single paper products in a tiled arrangement, in accordance with the generic clause of claim 1.

Printed products, such as for example advertising material or magazines, are manufactured by printing shops primarily in web printing machines, for example jobbing web offset, newspaper and intaglio machines. After printing, such machines place the product, arranged scale-like one upon another, onto a transport means such as a conveyor belt. One can say that the product is laid out in a so-called imbricated form upon the transport means.

The finished product is created in subsequent processing by trimming the top and bottom areas, as well as the usually open long side. Since the printed product is processed without intermediate storage and at the full speed of the transport means, this is called in-line processing.

Trimming during inline processing is not done by cutting the individual products but by handling a product stack, a so-called tile, in a first cutting machine, and after reorienting the tile by 90° via so-called corner deflectors, in a second cutting machine. High output of the printing presses requires processing in tiles in order to keep the transport speeds within reason. Trimming by tile has emerged as the most practicable solution because otherwise far longer and more costly processing would be required.

It is known in the art that trimming is done by a rotating upper knife, while under the tile a counter- or lower, knife is arranged, also rotating and usually being smooth, in order to absorb the resulting downward cutting forces so that the product cannot yield downward and thereby tear at the cutting edge.

For example, EP 0,450,338 A1 describes a cutting arrangement for cutting printed products comprising a rotating knife disk provided with a plurality of blades and acting against a counter-knife.

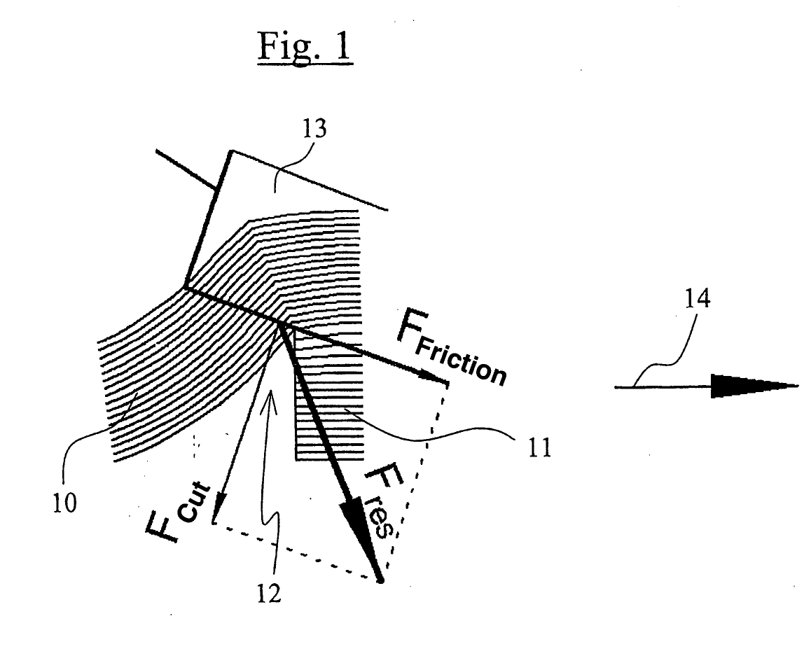

Recent technology makes it currently possible for modern printing presses to economically deliver products with up to 72 pages, at relatively high speeds. Trimming of the tiles by means of devices known from prior art results in an ever increasing quality problem. By arranging printed products in a tile, a hollow space is created before the next tile due to an overlap of the products. This is shown in FIG. 1. A hollow space 12 is formed between the upper product 10 and the lower product 11. Due to the hollow space, the counter-knife, not shown, cannot absorb the forces created in this space by the cutting action of the cutting blade 13. As can be seen in FIG. 1, during the cutting of the printed product, F_{Reibung[Friction]} and F_{Schnitt[Cut]} are created. The transport direction is represented by reference numeral 14. The resulting force Fᵣₑₛ therefore acts in the direction away from the cutting blade 13, as can be seen in FIG. 1. This causes a tear-out of the cut edge in the region of the hollow space 12. The thicker the tile or the individual product 10, 11, the greater the hollow space 12 and the greater the tear-out during cutting.

Various attempts to resolve this problem have been proposed in prior art.

To solve this problem, U.S. Pat. Nos. 5,113,731 and 5,809,856 propose singling of the products to avoid the tear-out. However, such a solution has the disadvantage of very high expense and high maintenance costs.

U.S. Pat. No. 5,197,364 describes a cutting arrangement where the cutting knife is located under the tile, which leads to a more advantageous force distribution since the resulting forces no longer act only vertically in relation to the paper fibers. Such arrangements have been in use for some time but it has been shown that the quality of the cut still falls short because a clearly visible tear-out still exists. Furthermore, such an arrangement also results in high costs because locating the main cutting knife below requires additional means such as for example swing-out cutting units.

DE 196 29 561 C1 therefore proposes an arrangement of cutting knives above and below the tile. Such an arrangement is, however, even costlier and more complex because in order to achieve good cutting results, the tile must be always guided centered between the cutting knives, which is very difficult due to varying heights of the tiles in the overlap and the non-overlap regions.

Also known from prior art are various cutting knives for rotational cutting devices for cutting paper, in particular single paper products in tiled formations. For example, U.S. Pat. No. 6,089,138 describes a rotating cutting knife with a cutting knife base and with cutting knives adjustably disposed in guide grooves, arranged along and extending above the circumference of said base and fixed in a holding arrangement extending conically from the center of the knife base toward its circumference. The ends of the cutting knives extend beyond the circumference of the knife carrier and form a cutting plane which is vertical to the rotational axis of the cutting tool. The cutting knives comprise an adjustable installation cross section within dovetail-shaped guide grooves and are held in pairs by a holding plate arranged between them and tightenable to the knife carrier.

DE 37 19 721 C1 discloses a cutting knife which acts together with a counter-knife and has a base body shaped substantially as a truncated cone with a cutting plane extending vertically relative to the rotational axis and comprising conically shaped support surfaces, while the blades are arranged on the rear side of the truncated-cone-shaped base body, said blades forming an angle relative to the cutting plane. The blades are disposed movable into various cutting positions and fixable.

However, these and other cutting knives known from prior art have the disadvantage of being very costly because they employ complex base bodies with inserted hardened-metal segments.

Furthermore, cutting knives known from prior art in most cases employ conically shaped cutting bodies with conical cutters. These have the disadvantage of causing great displacement of the material during the cutting. The displacement causes high forces which leads to tearing and therefore to poor quality of the cut.

DE 894 763 C discloses a knife designed as a form of saw blade with additional planing teeth. Displacement is far lower with such blade-shaped knives without conical shapes. However, said planing-tooth blade is intended for woodcutting, as is described in the document. Such a blade is unsuitable for paper cutting because at high speeds the planing teeth are tearing the paper rather than cutting it and therefore the cut edge does not have the desired quality.

On the basis of the above, the object of the present invention is to provide a process and device which makes it possible to achieve good cutting result at the least possible cost even at an increasing transport speed, and to correct the disadvantages of prior art.

The object is achieved by a cutting knife having the features of claim 1.

According to the invention, what is described is a cutting knife for rotational cutting installations for printed products made up of paper sheets in tiled formation or as single products, having a substantially round, disk-shaped cutting body, a rotational axis disposed substantially in the center of the disk and with cutting sections arranged at the disk edge. According to the invention, the cutting sections have at least two different and alternating areas with the first area comprising a saw tooth formed by notching the cutting body and the second area comprising a peeling blade. In relation to the thickness of the cutting body, the peeling blade is conical. This means that in this region the two surfaces of the cutting body converge toward the edge of the cutting body. In the second area, the cutting body has an at least partially greater radius than in the first area. Both surfaces of the substantially disk-shaped cutting body form a cutting edge at the periphery of the knife. When viewed in a clockwise rotation, said cutting edge has an edgeless, or step-less, transition to the next tooth ahead and extends outward in relation to the circumference of the cutting knife in the direction of rotation. One could also say that in relation to the tangent of the circle at the beginning of the edge, said edge extends in the direction outside of the circle.

When viewed rotating clockwise for cutting, an edge of the second area extends along the circumference of the cutting body and forms an angle ranging from 40° to 85° relative to the radius of the cutting body, and at least one area which contacts the printed products in operation has a cutting edge.

In a cutting knife according to the present invention, an area formed as a saw tooth is not necessarily directly followed by a second area that is formed as a peeling blade. Even though these two areas alternate, it does not mean that the cutting knife only has these two areas. It would be entirely imaginable for other cutting areas to be provided.

When disposed above the tile and rotating in the direction of the tile transport path, the cutting knife according to the present invention works as follows. The saw tooth removes material from the chip area and exerts a force downward. The next following peeling blade of the cutting knife cuts by means of its conical design into one side of the cut slit. This drawing cut results in a particularly good cut surface. The saw tooth therefore substantially cuts out volume. By contrast, the peeling cutter only slices a thin slot along the first cut—depending on the arrangement, either on the one or on the other side of the slot. This lateral surface of the cut is very clean and shows no tear-out.

Since the second area, comprising the peeling blade, has a greater radius “in the back” when viewed in clockwise rotation than the first area which comprises the saw tooth, i.e., since the cutting edge of the peeling knife protrudes “in the back” above the cutting circle of the saw tooth in the same direction of rotation, it is the peeling blade alone that determines the quality of the cut on that side toward which the cone of the peeling blade extends.

The cone of the peeling blade can extend either toward the one or the other margin of the cutting body thickness. If the peeling blades were to alternate their “cone direction” then both sides of the cut would have a very good surface and the cutting knife could be used to cut so-called center-cut products.

With regard to the sides of the cut, all conventional cutting knives deliver a product side which is qualitatively better, and a cutoff side with a very poor surface. By contrast, an arrangement according to the invention can produce good cut surfaces on both sides.

In contrast to the above-described high displacement forces of cone shaped knives such as those frequently employed in prior art, and to the poor quality of the cuts resulting therefrom, in particular in thicker products, a cutting knife according to the invention works entirely without lateral displacement forces because during the cutting a volume which corresponds to the thickness of the knife is removed from the material being cut. In order to keep this volume small, the knife according to the invention is advantageously as thin as possible. As a result, the saw teeth are also narrow, which reduces the cutting force, thereby lowering even further the risk of tear-out in the cut material.

In the cutting knife according to the present invention, the transition from the saw tooth to the peeling blade tooth is formed as a cutting area, at least in the area which in operation contacts the product, and because the peeling blade has an edge which extends at an angle outward relative to the knife circumference, it is the peeling blade that is in fact always in action, even with varying product transport speeds, and it is not “skipped over” as occurs for example in devices known from prior art. It has been shown for example in the knife known from DE 894 763 that peeling blades are arranged circular and concentrically to the hub in order to work without a “kick-back.” This produces an edge between the saw tooth and the peeling blade region, said edge having a triangular surface as seen in the direction of knife operation. This surface results in the tear-out of paper fibers as soon as the speed of the product transport increases.

In the knife according to the invention, however, the transition from saw tooth to peeling blade is formed as a cutting area. This can assure that even when the transport speeds vary, it is the cutting edge that comes into engagement, thereby making it possible to always obtain a good edge of cut.

According to a preferred embodiment of the present invention, the cutting knife is formed such that when the cutting body is viewed operating clockwise for cutting, the saw tooth is formed such that an edge extending circumferentially along the cutting body forms an angle ranging from 40° to 80° relative to the radius of the cutting body, and an edge extending toward the center of the cutting body forms an angle ranging from 10° to 45°.

Advantageously, the peeling blade of the cutting knife according to the invention is formed such that when the cutting body is viewed operating clockwise for cutting, the peeling blade is formed such that an edge extending circumferentially along the cutting body forms an angle ranging from 40° to 85° relative to the radius of the cutting body, an edge extending toward the center of the cutting body forms an angle ranging from −30° to 60° and a cone angle is in the range from 60 to 30°.

Moreover, it has been also shown to be advantageous if the edge extending circumferentially along the cutting body with an angle ranging from 40° to 80° relative to the radius of the cutting body is stepless.

Advantageously, the cutting body with the cutting areas can be formed substantially in one piece.

According to a preferred embodiment of the present invention, the cutting knife is embodied such that the thickness of the cutting body outside of the cutting regions is between 0.1 and 5 mm. The cutting forces exerted on the printed products can be kept as low as possible when the thickness of the cutting knife is as low as possible.

According to a preferred embodiment of the invention, the outer diameter of the cutting body measures between 50 and 250 mm. Since the cutting knife according to the invention can have relatively small dimensions, it can also be manufactured at a very low cost. Due to the low overall volume of the cutting knife, use of a knife made entirely of hardened metal is economically feasible.

The invention will be described in more detail by way of a preferred embodiment with reference to the drawings.

The drawings show

In FIG. 1, the arrangement of printed products in a tile and the force vectors during cutting according to a prior art process;

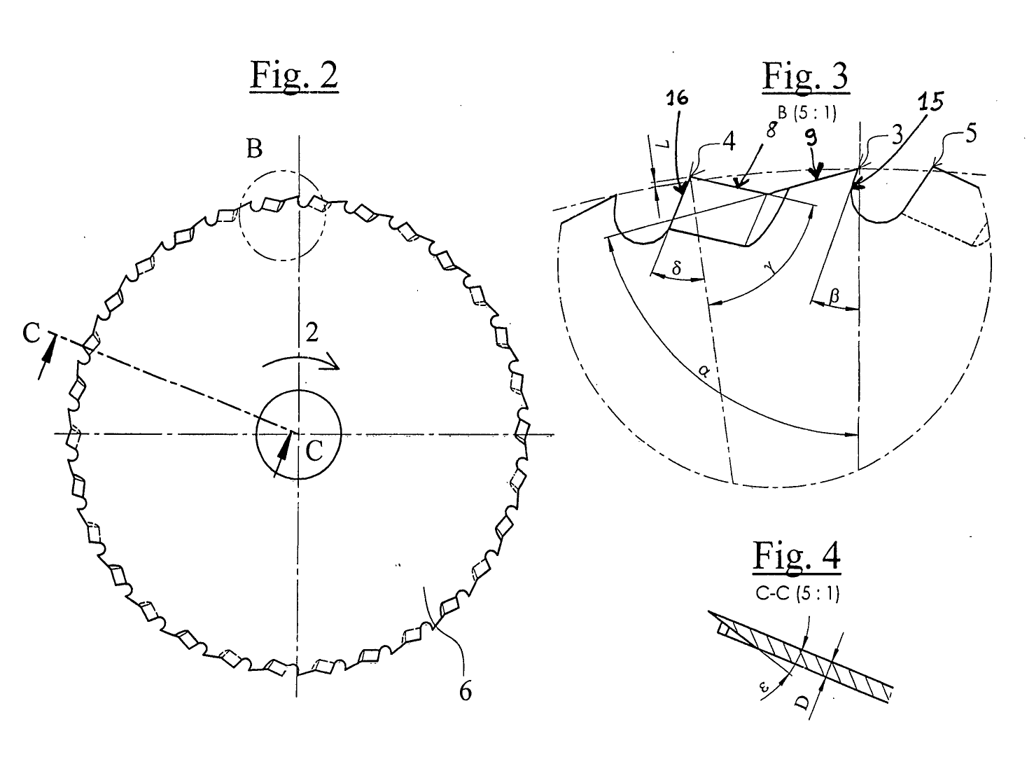

In FIG. 2, a cutting knife according to a preferred embodiment of the invention;

In FIG. 3, an enlarged detail of FIG. 2;

In FIG. 4, a section C-C of FIG. 2; and

FIG. 2 shows a cutting knife 1 according to the invention. In the illustration shown, the rotational direction 2 of such a knife is clockwise. The diameter of this cutting knife is 120 mm according to the preferred embodiment shown.

For a better view of the cutting sections 3, 4, 5 at the periphery of the cutting knife 1, the region B of Fig. is shown enlarged in FIG. 3.

According to a preferred embodiment of the invention, the cutting knife rotates at a relatively high rate of about 24,000 min⁻¹. In rotation of the cutting knife, a saw tooth 3 is followed by a peeling blade 4, 5.

According to the shown embodiment of the invention, saw tooth 3 is designed such that edge 9, extending circumferentially along the cutting body, forms an angle α of about 75° in relation to the radius of the cutting body edge 15, extending toward the center of the cutting body, forms an angle β of about 20°.

Furthermore, the illustrated cutting knife 1 has two differing second areas, the peeling blades 4, 5, each extending conically in each case toward the other side of thickness D of cutting knife 1. These peeling blades 4, 5 alternate, which means that notched saw tooth 3 is followed by peeling blade 4, which in turn is followed by another saw tooth 3, the latter being followed by peeling blade 5. According to the shown preferred embodiment, both edges 8 and 9 are stepless.

As can be seen in FIG. 3, peeling blade 4, 5 protrudes slightly above saw tooth 3. This is represented by reference numeral 7, and in accordance with the preferred embodiment this protrusion equals 0.2 mm. The protrusion has the effect that only peeling blades 4, 5 are responsible for the quality of the cut.

FIG. 4 shows a section C-C of FIG. 2, that is, a section through peeling blade 4, 5 of cutting blade 1 according to the invention.

According to the shown preferred embodiment, peeling blade 4, 5 is designed such that edge 8, extending circumferentially along cutting body 6 forms an angle γ of approximately 70° relative to the radius of the cutting body. Edge 16, extending toward the center of cutting body 6, forms an angle δ of approximately 30° relative to the radius and cone angle E is about 15° (see FIG. 4). Section C-C in FIG. 4 corresponds to a section though peeling blade 4. A section through a peeling blade 5 would be the same as a mirror image of FIG. 4.

Thickness D of cutting body 6 is 0.8 mm according to the shown preferred embodiment.

1. A cutting knife for rotational cutting installations for a flexible material said cutting knife comprising a substantially round, discoid cutting body with a rotational axis arranged substantially in a center thereof, said cutting body at a periphery thereof comprising cutting regions, said cutting regions comprising at least two different alternating areas, wherein a first of said areas is a sawing tooth formed by notching the cutting body and a second of said areas is a peeling blade extending conically in relation to a thickness of the cutting body toward the periphery of the cutting knife, said cutting body having in the second area a radius at least partially larger than in the first area, wherein when the cutting body is viewed rotating clockwise, an edge of the second area extends circumferentially along the cutting body and forms an angle ranging from 40° to 85° in relation to a radius of the cutting body, and at least one cutting body section that comes into contact with the flexible material being cut has a cutting edge.

2. The cutting knife according to claim 1, wherein when the cutting body is viewed rotating clockwise, the sawing tooth has an edge extending circumferentially along the cutting body so as to form an angle ranging from 40° to 85° in relation to the radius of the cutting body and an edge extending toward the center of the cutting body, forms an angle ranging from 10° to 45° in relation to the radius of the cutting body.

3. The cutting knife according to claim 1, wherein when the cutting body is rotating clockwise, an edge of the peeling blade extends toward a center of the cutting body to form an angle ranging from −30° to 60° and a cone angle ranging from 6° to 30°.

4. The cutting knife according to claim 1, wherein the second area extends conically in relation to a thickness of the cutting body alternately to one edge and thereafter to another edge of the cutting body.

5. The cutting knife according to claim 1, wherein the cutting body is substantially formed in substantially one piece.

6. The cutting knife according to claim 1, wherein the thickness of the cutting body beyond the cutting areas ranges from 0.1 to 5 mm.

7. The cutting knife according to claim 1, wherein an outer diameter of the cutting body ranges from 5 to 250 mm.

8. The cutting knife according to claim 1 wherein the flexible material is paper, plastic, cloth, leather or wood.

9. The cutting knife according to claim 1 wherein the flexible material is a multilayer discrete paper product arranged in a tiled formation.
